(19) United States
(12) Patent Application Publication
(10) Pub. No.: US 2018/0285419 A1
(43) Pub. Date: Oct. 4, 2018

(54) METHOD OF SPARSE ARRAY IMPLEMENTATION FOR LARGE ARRAYS

(71) Applicants: VICTOR CHERNOV, MOSCOW (RU); ANDREY PORTNOV, MOSCOW (RU); VLADISLAV GOLOVKOV, MOSCOW (RU)

(72) Inventors: VICTOR CHERNOV, MOSCOW (RU); ANDREY PORTNOV, MOSCOW (RU); VLADISLAV GOLOVKOV, MOSCOW (RU)

(21) Appl. No.: 15/724,113

(22) Filed: Oct. 3, 2017

Related U.S. Application Data
(63) Continuation-in-part of application No. 14/680,704, filed on Apr. 7, 2015, now abandoned.

(51) Int. Cl. G06F 17/30

(52) U.S. Cl. CPC G06F 17/30463; G06F 17/30324

(57) ABSTRACT

Apparatuses, systems, and methods are disclosed for a key-value store. The method includes associating positions within a sparse array with key values on a one-to-one basis. Intermediate searchable containers of value pairs are sized for improve search efficiency. Containers that reach a maximum count of key value pairs are divided into derivative containers that each contain approximately one half of their originating container.

### FIELD OF THE INVENTION

The present invention relates to the techniques and systems adapted for searching software databases. More particularly the present invention relates to methods and systems effective in searching databases comprising key value pairs wherein database records are associated with keys.

### BACKGROUND OF THE INVENTION

A key value pair is a set of data items that contain a key, such as an account number or part number, and a value, such as the actual data item itself or a pointer to where that data item is stored on a disk or some storage device. Key value pairs are widely used in tables and configuration files. When loading large numbers of key value pairs into memory, however, memory space can quickly run, out and the computational burden of search can be expensive both in resource requirements and financial costs.

In prior art methods, each key (i.e, one or more keys may be or comprise an alphanumeric value, an alphabetic representation, a digitized symbolic character string, and/or a numerical value) corresponds to a set of values, e.g., a document, whereas in the method of the present invention, optionally only one value corresponds to one key.

Both the method of the present invention and the prior art may apply, form or use a set of subindexes. However, the prior art uses a two-dimensional matrix consisting of references to B+tree, whereas the method of the present invention uses a one-dimensional array of references to groups, wherein the one-dimensional array of references to groups may be optionally represented as an array or a hash table.

In the prior art, each element of a matrix contains a reference to a separate index whereas in the method of the present invention several different elements of an array can optionally refer to a same group. This optional feature wherein several different elements of an array can optionally refer to a same group distinguishes certain alternate preferred embodiments of the method of the present invention, whereby certain alternate preferred embodiments of the method of the present invention is distinguishable from various versions of searches applying tree structures.

When referring to the matrix, certain prior art methods use a hash function of key, e.g., a word identification number, in the process of selecting a required subindex. In patentable distinction, certain yet alternate preferred embodiments of the method of the present invention, when accessing an array to select a required group, use a simple division operation or a right shift of a couple of bits. This optional aspect of the method of the present invention leads to the result that, in the course of resolving certain problems when processing a sequential search, the probability of finding the sought for data in the processor cache of a computational device is substantially higher, whereby the operation of the method of the present invention is most significantly speeded up.

The method of the present invention is particularly suitable for application by a random access memory and/or a system memory of computational device, whereas prior art methods are typically designed for full-text search and are optimized for working with and employing a hard disk memory module or device.

These differences of the prior art with the method of the present invention significantly affect the speed of searching for keys in certain computational search tasks. The search speed when using certain prior art methods depends on each specific implementation and lies between the speed of the hash table and the speed of a B-tree, whereby these prior art methods are generally slower than the method of the present invention.

To speed up searches of key-value pairs, the prior art variously applies some specialized structures called map-structures or indexes, these prior art methods include:
Array;
Sparse array;
various variants of Hash tables;
various variants of B-trees, including B+, B*, and etc.;
various variants of binary trees; and
various variants of tree data structures, also called digital tree, radix tree or prefix tree.

The main operational factors of computational performance among these prior art methods are the search speed and the amount of memory used to store the selected key-value pair set S.

The prior art array method has a high speed of solving the certain problems, wherein search speed is proportional to sequential memory access time, e.g., and random access memory access time. However, prior art array method takes the maximum amount of memory as compared to other structures listed here, wherein the required memory capacity may be proportionally related to cell memory size multiplied by the N value.

Prior art sparse array techniques resolves key-vale searches with high speed, wherein search speed is related to the N value multiplied by the time of sequential access to values. The search speed is approximately equal to the one for the array, in some cases it can be a little faster. The prior art sparse array method presents the average indicators for memory used among the prior art methods listed here. The prior art sparse array method require and amount of memory related to dell memory size and the value (SN*K+N/K), where SN is the number of key value pairs and K is greater than 1. In most implementations the group size is in the range from 16 to 256.

Still other prior art methods apply hash tables to search key-value pairs at average speed, wherein the search speed is related to the time of random access to the accessed memory. Unlike the array, time of random access to memory is incurred, which is often approximately 20 to 30 times longer than the sequential time for modern computers. The K value in most prior art hash table implementations is typically in the range from 1 to 2. The amount of memory required by prior art hash table methods is related to memory cell size, the count of SN key0-value pairs, and a K value, where the K value is generally approximately 2 and typically many times smaller than seen in prior art sparse array key-value search methods.

Prior art key-value searches applying B-Trees perform searches at average speed, wherein their search speeds are related the N value of key value range, * memory cell sequential access, and the log 2 of the maximum key value of N, and the minimum required memory size for such prior art methods are proportional to memory cell size and the count of key-value pairs SN

The search speeds of key-value pairs of prior art methods employing suitable variants of binary trees known in the art is comparable with the search speeds of prior art methods that employ B-trees and amount of memory required is slightly larger than the memory size required by B-trees.

The search speeds of key-value pairs of prior art methods employing other suitable variants of trees present search speeds of key-value pairs several times less than the search speed of the sparse array in most implementations, but faster than B-Trees and binary trees, and require and amount of memory that is usually several times larger than the memory required by prior art methods that employ B-trees.

There is therefore a long-felt need to provide improved methods and systems for performing searches in databases containing key value pairs, wherein speed of search computational search operations of database management system are preferably increased while the amount of electronic memory required to successfully perform such operations is reduced.

### SUMMARY OF THE INVENTION

Toward this object and other object made obvious in light of the present disclosure, an invented method and system are provided that present and apply an algorithm designed to solve one set of information technology database search challenges. In certain alternate preferred embodiments of the invented method, a set S of key-value pairs is examined, wherein each key may be an integer number located in the range from 0 to some (preferably large) maximum value N, e.g., N is equal to or greater than one billion, and wherein the total quantity of key-value pairs in the S set is preferably far less than N, e.g, there might be fewer key-value pairs than one half of the N value. When it is necessary or desirable or simply elected to proceed through the key-pairs in an ordered sequence of the keys, wherein one or more keys are optionally a number, from an initial key to a final key of the key series of the S set of key-value pairs, the method of the present invention attempts to find among the set S elements the values associated with each applied key of the S set of key-value pairs. The keys may then be examined and applied in the instant process sequentially in order from a first key to a last key of the series of keys. In the case that no the key is thereby found in S set of key-values. i.e. the S key-value set doesn't contain any key being or having the key being searched, the invented method teaches that the sought-for key was not found.

It is understood that it is preferable that all data related to the instant search operation of the method of the present invention is found or represented in one or more an accessible memory modules, system memories, or memory devices.

Certain yet alternate preferred embodiments of the invented method may be implemented by or in accordance with the following pseudocode:

for(int i=0; i<N;i++){

ValueType v = map(i);
if( v != <emptyvalue>){

// now we have value: v for key: i
// and can process it

}else{

//value not found for key i

}

}

The algorithm and data structure of the method of the present invention differs from the prior art methods and provides preferred search speeds and the amounts of memory used to search sets of key-value pairs, and especially so in case of strongly sparse data, i.e., wherein the count of key-value pairs is many times less than a maximum N key value. In the method of the present invention, the search speed is proportional to a search speed of an equivalent sparse array and amount of memory required is proportional to a memory cell size multiplied by (SN value*K1+N/K2)

It is understood that both the K1 value and the K2 value can vary depending on the characteristics of a particular implementation. For example, in one of the implementations K1˜2 and K2=64*1024.

Thus, the structure method of the present invention provides a speed of search comparable to and/or in the order of the maximum speed of the prior art methods, while requiring for implementation an amount of memory used comparable to the minimum volume of the prior art methods.

In certain still other alternate preferred embodiments of the method of the present invention, a sparse array is associated with intervening containers, wherein the sparse array includes at least as many locations as uniquely expressed in a range of key values of a plurality of keys of a selected multiplicity of key value pairs. Each container is dynamically managed to contain, or relate to, less than a maximal count of key value pairs, wherein any container exceeding the maximal count of associated keys is split into two substantively equally sized derivative containers.

Alternatively, indices are applied in certain alternate preferred embodiments of the method of the present invention (hereinafter, “the invented method”) wherein one or more distinguishable elements of the sparse array represent a unique key value and point to one particular index of a plurality indices, wherein each index is associated with a unique and sequential range of key values, but no index stores a key value pair. The term pointer as applied within the present disclosure is defined to include information that may be digitized and/or stored in electronic media including, but not limited to, memory; further included is data that may be or comprise a representation of information that enables access to, and/or specifies the location of, a key value pair. The term pointer is further defined herein as to include, be or comprise a pointer, a cursor, an index, or other digitized information stored in an electronic storage media, wherein the digitized information may comprise a representation of information that enables access to, and/or specifies the location of, a key value pair.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE FIGURES

These, and further features of the invention, may be better understood with reference to the accompanying specification and drawings depicting the preferred embodiment, in which:

FIG. 1 is a diagram of a sparse array as stored in a computer memory wherein each element of the sparse array contains a pointer to a container, each container containing or associating a maximum of M key value pairs;

FIG. 2 is a diagram presenting a plurality of containers;

FIG. 3 is a diagram illustrating the splitting of a container;

FIG. 4 is a flow chart of the interactivity of the software of FIG. 3;

FIG. 5 is a flowchart of computer searching for a value with a key;

FIG. 6 is a flowchart of a further aspect of the invented method whereby the computer adds a key and value pair to a container;

FIG. 7 is a flowchart of a yet further aspect of the invented method whereby a database management software directs the computer to increases the array size;

FIG. 8 is a flowchart of a yet further aspect of the invented method wherein the database management software directs the computer to execute a first method to of splitting a group;

FIG. 9 is a flowchart of a yet further aspect of the invented method whereby the database management software directs the computer to utilize a second method for the execution of a process of splitting a group;

FIG. 10 is a flowchart of a yet further aspect of the invented method, whereby the computer utilizes a third method of splitting a group;

FIG. 11 is a flowchart of a yet further method of the invented method, whereby the database management software directs the computer to delete a key and value pair;

FIG. 12 is a block diagram of the computer of FIG. 1 through FIG. 11; and

FIG. 13 is a block diagram of a database management system of the computer of FIG. 12, wherein a plurality of data structures of the methods of FIGS. 5 through 11 are stored.

### DETAILED DESCRIPTION

In the computer sciences a key and data pair is a system by which a value, such as a data-containing record, is matched with a key, wherein each key is a unique value found within a key range.

Inefficiencies persist in the prior systems, however, particularly when a plurality of containers, i.e., a plurality of distinguishable software structures, are assigned in the aggregate to that contain a very large number of key value pairs.

When a plurality of software encoded containers (hereinafter, “containers”), are each assigned a one or more key value pairs selected from a large number of key and value pairs, for example greater than 100,000,000, a search applying a particular search key may take an extensive amount of time, even searching only the keys recorded in or associated with each container. The invented method seeks to remedy such inefficiencies by means of implementing a sparse array within a memory of, or a memory accessible to, an information technology system tasked with searching for key matches.

It is understood that, in various alternate preferred embodiments of the invented method, one or more containers may be or comprise, a database, a software object, a subroutine, and/or other suitable data structure known in the art.

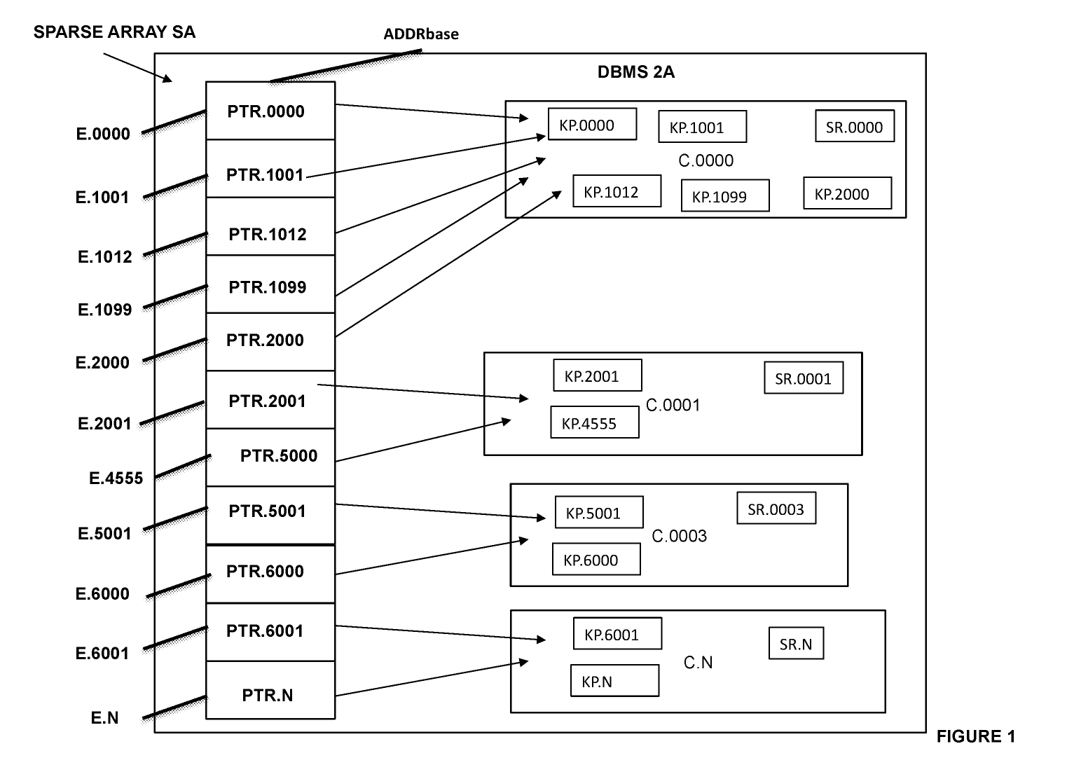

Referring now generally to the Figures, and particularly to FIG. 1, FIG. 1 is a diagram of sparse array SA as stored in a computer 2 having a database management system 2A (hereinafter, “DBMS 2A”) stored in a system memory 2B. It is understood that each and every software data, record, software object, encoded information or digitized information referenced in the present disclosure may be stored in the system memory 2B and/or the DBMS 2A.

The DBMS 2A may be or comprise one or more prior art database management systems including, but not limited to, an ORACLE DATABASE™ database management system marketed by Oracle Corporation, of Redwood City, Calif.; a Database 2™, also known as DB2™, relational database management system as marketed by IBM Corporation of Armonk, N.Y.; a Microsoft SQL Server™ relational database management system as marketed by Microsoft Corporation of Redmond, Wash.; MySQL™ as marketed by Oracle Corporation of Redwood City, Calif.; and a MONGODB™ as marketed by MongoDB, Inc. of New York City, USA; and the POSTGRESQL™ open source object-relational database management system.

The computer 2 may be or comprise a bundled computer software and hardware product such as, (a.) a network-communications enabled THINKPAD WORKSTATION™ notebook computer marketed by Lenovo, Inc. of Morrisville, N.C.; (b.) a NIVEUS 5200 computer workstation marketed by Penguin Computing of Fremont, Calif. and running a LINUX™ operating system or a UNIX™ operating system; (c.) a network-communications enabled personal computer configured for running WINDOWS SERVER™ or WINDOWS 8™ operating system marketed by Microsoft Corporation of Redmond, Wash.; (d.) a MACBOOK PRO™ personal computer as marketed by Apple, Inc. of Cupertino, Calif.; or (e.) other suitable computational system or electronic communications device known in the art capable of providing or enabling a web service known in the art.

The DBMS 2A and/or the system memory 2B store a plurality of software containers C.0000-C.N, where N is an arbitrarily large integer. The plurality of software containers C.0000-C.N are each temporarily and sequentially bounded to a contiguous subrange of keys K.0000-K.N of a key range KR of a multiplicity of sequentially ordered elements E.000-E.N.

In the invented method, a sparse array memory space SAmem preferably comprises a multiplicity of ordered elements E.0000-E.N, wherein each element individually and uniquely relates a key K.0000-K.N of a specific sequence of a key range KR. The key range is defined as the extending from a minimum value of an initial key Kmin associated with an initial element E.0000, to a maximum value of a key Kmax associated with a maximum element E.N. The instant key range KR thus extends from Kmin to Kmax and the sparse array memory space SA has a separate element for each possible key K.0000-K.N within the instant key range KR. A base address ADDRbase of the sparse array memory space SAmem would be equal to a first memory location M.LOC.0000 within the system memory 2B, wherein is the base address ADDRbase of an initial element E.0000 of the sparse array memory space SAmem corresponds to the initial key Kmin.

Each sparse array element E.0000-E.N is sized to contain a pointer PTR.0000-PTR.N that expresses a memory location M.LOC.0000-M.LOC.N of a particular container C.000-C.N. For example, the initial subrange SR.0000 defines an initial plurality of elements E.0000-E.N that each contain a pointer PTR.000-PTR.2000 that points to the same initial container C.0000. The term “pointer” as applied within the present disclosure is defined to include information that may be digitized and/or stored in electronic media including, but not limited to, system memory 2B; further included is data that may be or comprise a representation of information that enables access to, and/or specifies the location of, a key value pair KP.0000-KP.N. The term pointer is further defined herein as to include, be or comprise a pointer, a cursor, an index, or other digitized information stored in an electronic storage media, wherein the digitized information may comprise a representation of information that enables access to and/or specifies the location of, a key value pair KP.0000-KP.N.

It is understood that each key K.0000-K.N is sequentially ordered from Kmin to Kmax, wherein the minimum key value Kmin is the initial key value K.0000 of the key sequence and the maximum key value Kmax is the highest key value K.N of the sequence. Each key K.0000-K.N is assigned a unique numerical position value within the sequence of the key range KR.

The sparse array memory space SAmem allocated to instantiate the sparse array SA comprises a contiguous block of memory locations M.LOC.0000-M.LOC.N, the size of memory allocated to instantiate the sparse array memory space SAmem would be equal to the memory size produced by the following calculated as follows:

SAsize=(Kmax−Kmin)(Pointer Size).

In another optional aspect of the invented method, when a particular key K.0000-K.N is selected as a search key Ksearch, the unique numerical position value Kvalue of the search key within the sequence of the key range KR is applied to make a determination of a memory location M.LOC of an element E.0000-E.N of the sparse array SA that represents a search key Ksearch may be generated by the following calculation:

M.LOC=(Kvalue−Kmin)(Pointer Size)+ADDRbase;

Wherein the base address value ADDRbase is a numerical or alphanumeric designation of the address within the system memory 2B of the initial element of the sparse area SA.

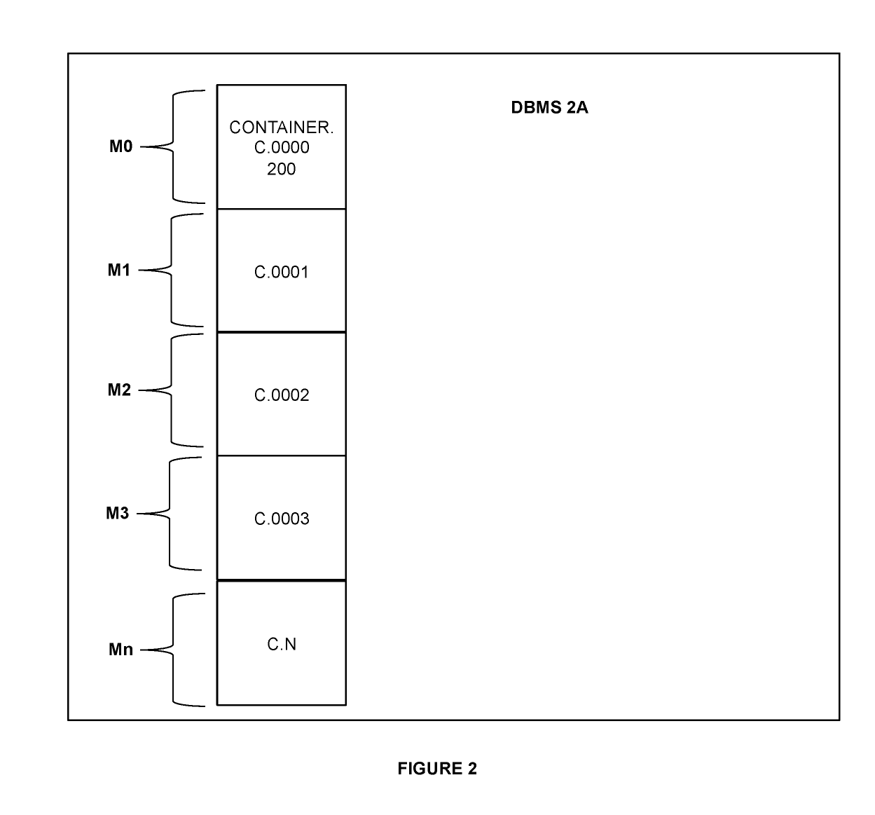

Referring now generally to the Figures, and particularly to FIG. 2, FIG. 2 represents an aspect of the invented method wherein each container C.0000-C.N is temporarily assigned to a bounded subrange SR.0000-S.N of keys K.0000-K.N of the key range KR, and wherein each container C.0000-C.N is associated with a maximum count M0-Mn of actual key value pairs KP.0000-KP.N selected its assigned bounded subrange of keys K.0000-K.N. Each container C.0000-C.N optimally stores a plurality of key value pairs KP.0000-KP.N, wherein each key value pair KP.0000-KP.N stored in each container C.0000-C.N includes a key K.0000-K.N of the key subrange SR.0000-S.N assigned to the comprising container C.0000-C.N. For example, the initial container C.0000 is assigned a contiguous first key subrange K.0000-K.2000 of two thousand sequential key values, wherein the initial container C.0000 may store only an initial container maximum key M0 of key value pairs KP.0000-KP.N. In an optimal application of the invented method, the initial container maximum key M0 is generally less than the number of unique keys K.0000-K.N associated with the contiguous first key subrange K.0000-K.2000.

Furthermore, in an optional aspect of the invented method, one or more containers C.0000-C.N may be associated with the same unique maximum key value pair count M0 or alternate maximum key value pair counts M1-Mn. More particularly, one exemplary preferred embodiment, the initial container C.0000 may have a maximum key value pair count M0 equal to an exemplary count of two thousand keys K.0000-K.N, and a third container C.0003 have an alternate third maximal count M0 equal to an alternate exemplary count of ten thousand keys K.0000-K.N.

It is further understood that each container C.0000-C.N may be temporarily assigned to a different and varying bounded subrange SR.0000-SR.N of the key range KR. For example, the initial container C.0000 may be assigned to an initial subrange SR.0000 of the key range KR from the minimum key value Kmin to an initial container subrange upper bound KC0+, wherein the initial container subrange SR.0000-SR.N upper bound KC0+ is temporarily equal to the minimum key value Kmin plus 2,000. In another optional example, a second container C.0002 may be assigned to a second subrange SR.0002 of the key range KR from the key value K.20001 to the key value K.5000. In yet another optional example, a third container C.0003 may be assigned to a third subrange SR.0003 of the key range KR from minimum key value K.5001 to a third container subrange SR.0003 upper bound key value K.6000.

It is understood that containers C.0000-C.N seldom generally store a key value pair KP.0000-KP.N for each key value K.0000-K.N of its particular assigned key subrange SR.000-SR.N

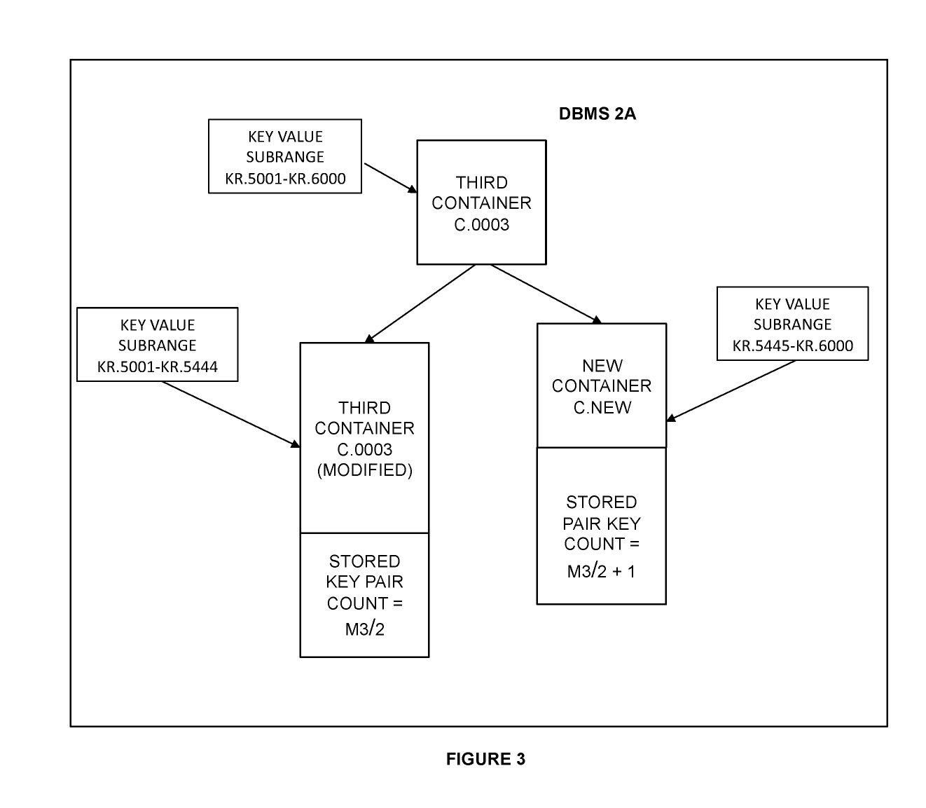

Referring now generally to the Figures, and particularly to FIG. 3, FIG. 3 is a diagram illustrating the splitting of a container C.0000-C.N which occurs when an assigned key maximum M0-Mn of the selected container C.0000-C.N is exceeded. It is understood that, in various alternate preferred embodiments of the invented method, two or more, or all, of the containers C.0000-C.N may have an assigned key maximum M0-Mn that is a same value, and that in still other alternate preferred embodiments of the invented method one or more containers C.0000-C.N may have a unique assigned key maximum M0-Mn.

When a new key value pair KP.0000-KP.N within the key range KR.5001-KR.6000 is added to the exemplary third container C.0003 and that addition causes the third container C.0003 to reach the third maximum key number M3 of keys that that may be assigned to the third container C.0003, the actually assigned key value pairs KP.5001-KP.6000 of the third container C.0003 are split between the third container C.0003 and a new container C.NEW. The new container C.NEW may consist of a key count Kcount equal to one half of the third maximum key number M3. It is understood that the new, resultant and reduced subrange KR.5001-KR.5444 of the third container C.0003 is contiguous, as is the resultant new key range subrange KR.5445-KR.6000 of the new container C.NEW. The third subrange SR.0003 of the third container C.0003 is therein modified start at the original first key position K.5001 of the third container C.0003 and the resultant new key range subrange KR.5445-KR.6000 of the new container C.NEW will end at the precious maximum key value K.6000 of the third container C.0003. In the exemplary process of FIG. 3, the third container C.003 is modified to store a reduced quantity of keys value pairs KP.50001-KP.5444 equal to one half of the third maximum key number M3 and comprising keys found within a reduced key value range KR.5001-KR.5444, and the new container C.NEW is populated with a quantity of key value pairs KP.5445-KP.6000 equal to one plus one half of the third maximum key number M3 and comprising keys found within a reduced key value range KR.5445-KR.6000.

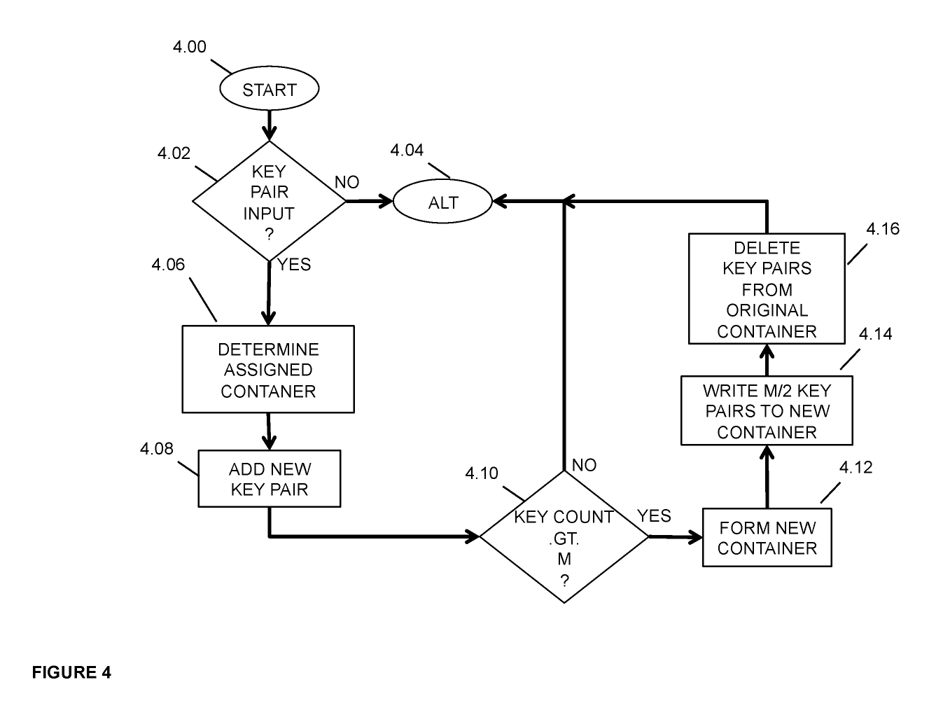

Referring now generally to the Figures, and particularly to FIG. 4, FIG. 4 is a flowchart of an aspect of the invented method wherein the computer 2 including a CPU 2C optionally creates the new container C.NEW. In step 4.02 the CPU 2C determines whether a key value pair KP.0000-KP.N containing a key K.0000-K.N input has been received. When the determination in step 4.02 is negative, the CPU 2C proceeds to step 4.04, wherein the CPU 2C executes an alternate process. Alternatively, when the determination in step 4.02 is positive, the CPU 2C determines in step 4.06 which element E.0000-E.N is associated with the keys K.0000-K.N received in step 4.02, and reads the pointer PTR.0000-PTR.N stored in the associated element E.0000-E.N, and thereby determines which container C.0000-C.N to store the key value pair KP.0000-KP.N received in step 4.02. Subsequently, in step 4.08 the CPU 2C adds the new key value pair KP.0000-KP.N to the container C.0000-C.N selected in step 4.06.

In step 4.10 the CPU 2C determines whether the stored count of key value pairs KP.0000-KP.N stored in the selected container C.0000-C.N of step 4.08 is greater than the assigned maximum number M0-Mn of keys of that selected container C.0000-C.N. When the determination in step 4.10 is negative, and the CPU 2C determines that the stored key value pair count of the designated container C.0000-C.N selected in step 4.06 is not greater than the maximum key number M0-Mn assigned to the selected container C.0000-C.N, the CPU 2C proceeds to step 4.20 and executes alternate processes.

In the alternative, when the determination in step 4.12 is positive, i.e. the CPU 2C determines that the count of key value pairs KP.0000-KP.N currently stored within the selected container C.0000-C.N is greater than associated maximum key value pair KP.0000-KP.N number M0-Mn of that selected container, the CPU 2C forms a new container C.NEW in step 4.12. In step 4.14 the CPU 2C writes the maximum number M0-Mn of key value pairs KP.0000-KP.N of the selected container C.0000-C.N divided by two into the new container C.NEW, wherein the key value pairs KP.0000-KP.N written in to the new container C.NEW are sequential and include either the lowest key value or the highest key value of the earlier formed container C.0000-C.N selected in step 4.08. In step 4.16 the CPU 2C deletes all key value pairs KP.0000-KP.N from the selected container C.0000-C.N that were written into the new container C.NEW in step 4.14. The CPU 2C subsequently proceeds from step 4.16 to step 4.04 and executes alternate processes.

It is understood that the function of the containers C.0000-C.N may be provided by a plurality of indices that do not store key value pairs KP.0000-KP.N but rather are each related to unique key value pairs KP.0000-KP.N stored within or accessible to the computer 2.

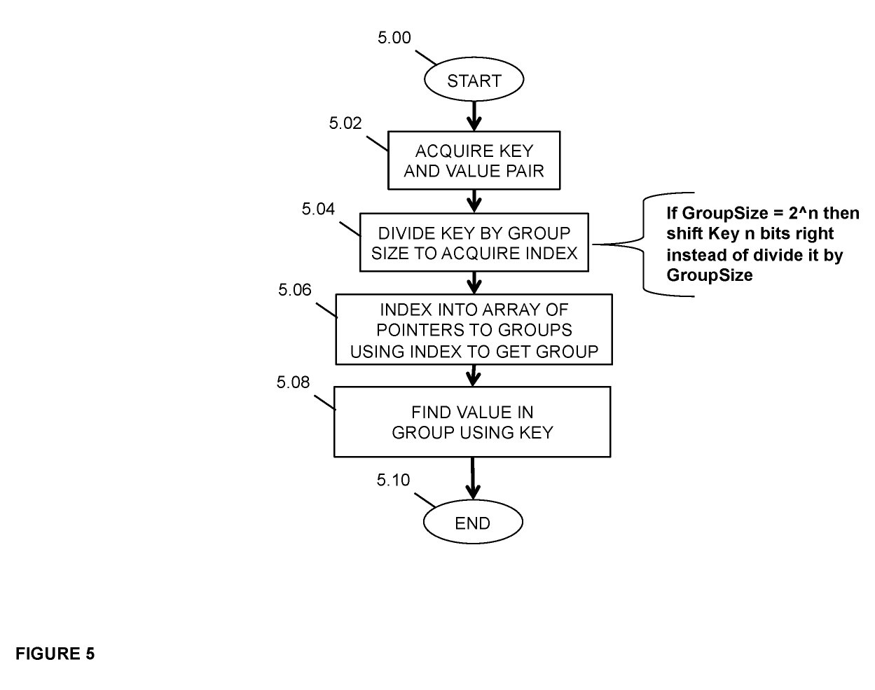

Referring now generally to the Figures, and particularly to FIG. 5, FIG. 5 is a flowchart of an aspect of the invented method whereby a CPU 2C searches for a key K.0000-K.N with a search value. In step 5.02 an invented software 4 of the computer 2 directs the CPU 2C to acquire a bitset 6. In step 5.04 the CPU 2C divides the key K.0000-K.N by a container size 8 for the purpose of acquiring an index 10. Alternatively, if the container size 8 is equal to 2″ the key K.0000-K.N is shifted n bits to the right, instead of the key K.0000-K.N being divided by the container size 8. In step 5.06 the CPU 2C places the index 10 into an array of references to groups 12, using the index 10 to acquire a group 14, wherein the group 14 may be, but is not limited to, a hash table. In step 5.08 the CPU 2C determines a value for the group 14 using the key K.0000-K.N. The CPU 2C subsequently advances to step 5.10, wherein the CPU 2C terminates the process.

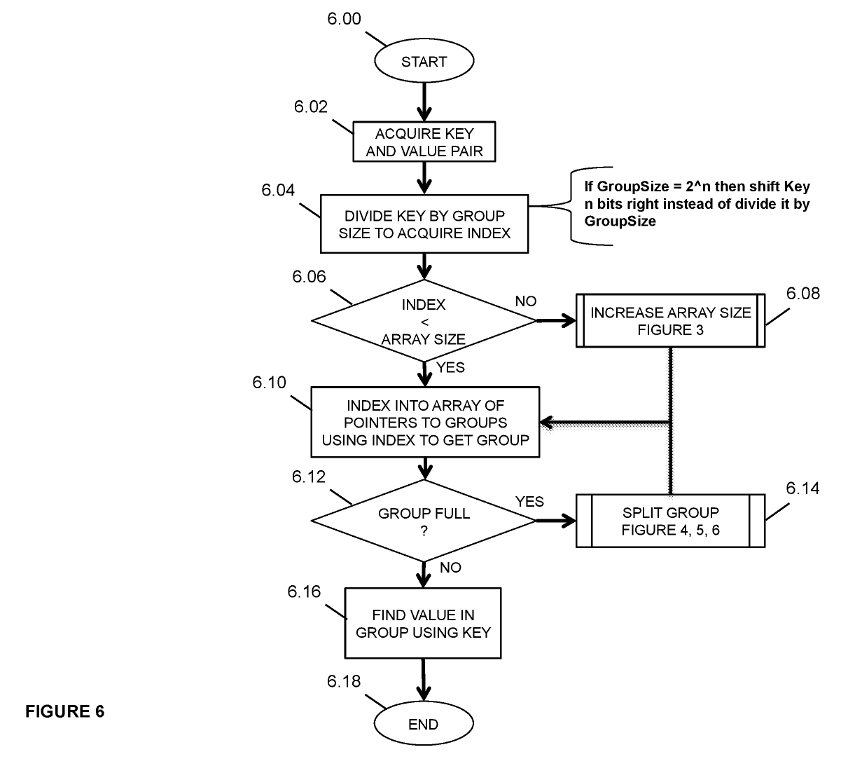

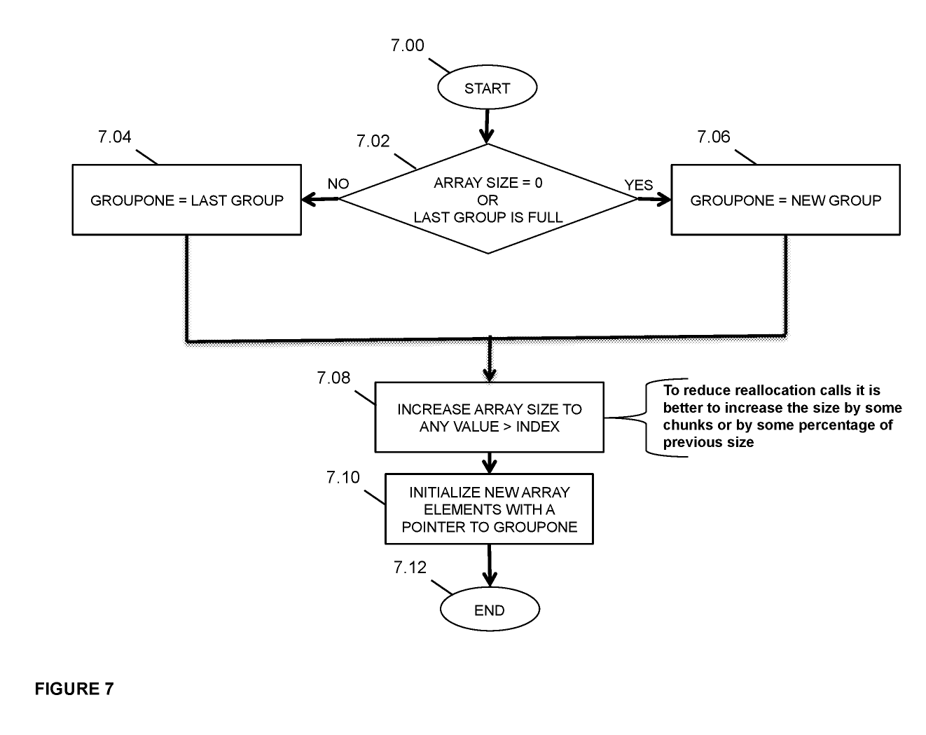

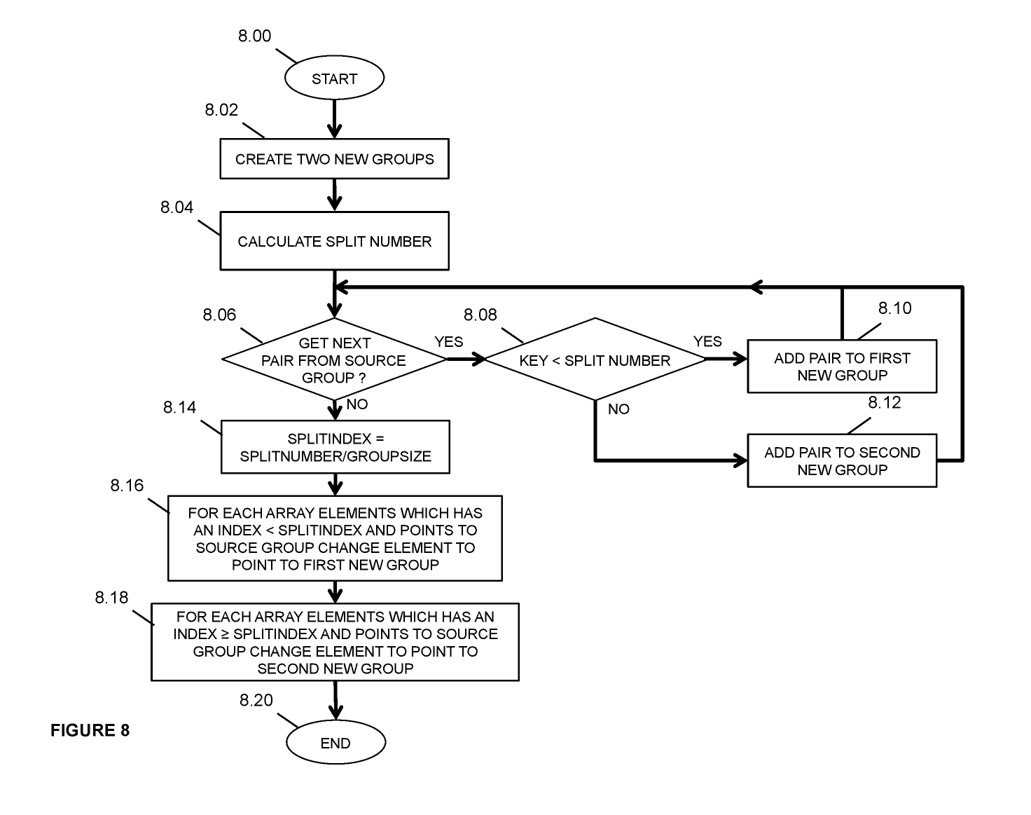

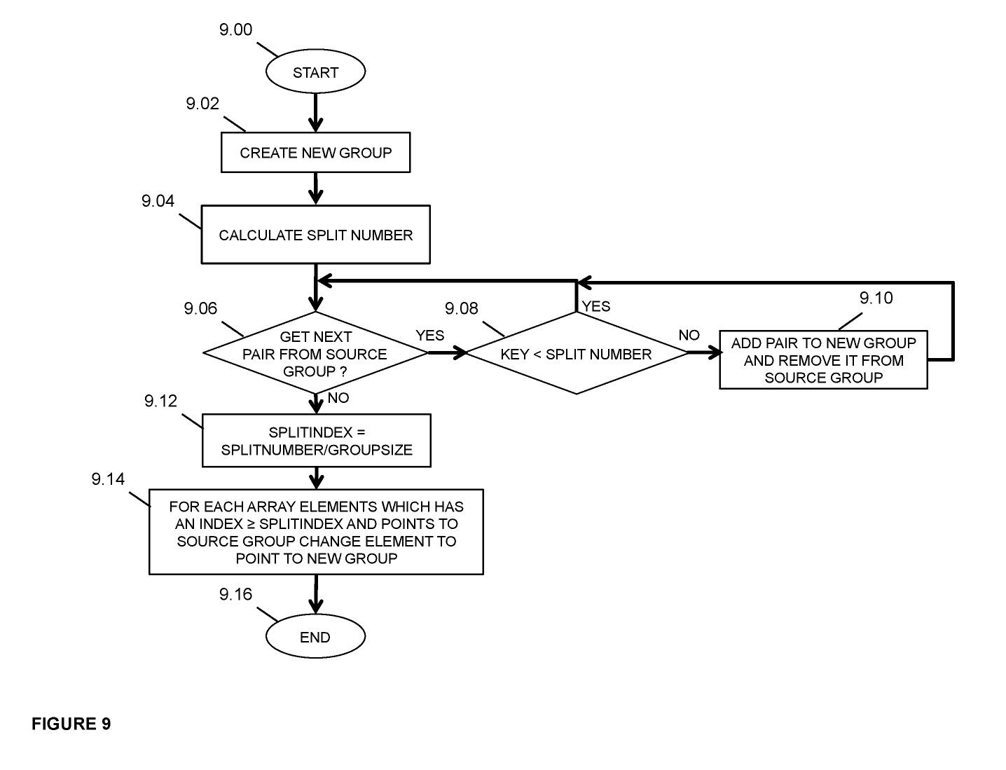

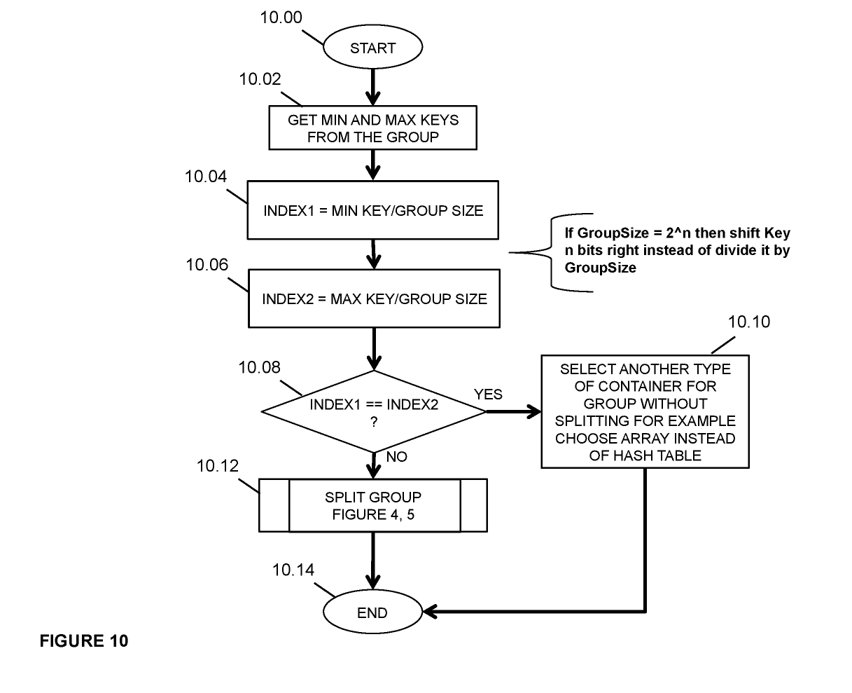

Referring now generally to the Figures and particularly to FIG. 6, FIG. 6 is a flowchart of a further aspect of the invented method whereby the CPU 2C adds a bitset 6 to a container C.0000-C.N. In step 6.02 CPU 2C acquires the bitset 6. In step 6.04 the CPU 2C divides the key K.0000-K.N by the container size 8 for the purpose of acquiring the index 10. In an optional alternative to step 6.04, the CPU 2C shifts the key K.0000-K.N n bits to the right if the group size is equal to 2ⁿ, instead of dividing the key K.0000-K.N by the group size. In step 6.06 the CPU determines whether the index 10 is greater than an array size 18. When the determination in step 6.06 is negative, i.e. the CPU 2C determines that the index 10 is not greater than the array size 18, the CPU 2C advances to step 6.08. In step 6.08 the CPU 2C increases the array size 18 by means of the method of FIG. 7. Alternatively, when the determination in step 6.06 is positive, and the CPU 2C determines that the index 10 is greater than the array size 18, the CPU 2C advances to step 6.10. In step 6.10 the CPU 2C indexes into the array of references to groups 12, using the index 10 to acquire the group 14. In step 6.12 the CPU 2C determines whether the group 14 is full. If the CPU 2C determines in step 6.12 that the group 14 is full, the CPU 2C advances to step 6.14, wherein the CPU 2C executes the methods of FIG. 8, FIG. 9, and FIG. 10. When the CPU 2C determines in step 6.12 that the group 14 is not full, the CPU 2C advances to step 6.16, wherein the CPU 2C adds the bitset 6 to the group 14. The CPU 2C subsequently advances to step 6.18, wherein the CPU 2C terminates the process.

Referring now generally to the Figures, and particularly to FIG. 7, FIG. 7 is a flowchart of a yet further aspect of the invented method whereby the software 4 directs the CPU 2C to increase the array size 18. In step 7.02 the CPU 2C determines whether the array size 18 is equal to zero, or alternatively whether a last group 18 is full. When the CPU 2C determines that neither of the criteria set out in step 7.02 are designated “true” the CPU 2C advances to step 7.04, wherein the CPU 2C sets a group one 20 equal to the last group 18. When the CPU 2C determines in step 7.02 that the either of the criteria set out in step 7.02 are met, the CPU 2C sets the group one 20 equal to a new group 22. When the CPU 2C has executed either step 7.04 or alternatively step 7.06, the CPU 2C advances to step 7.08. In step 7.08 the CPU 2C increases the array size 18 to any value that is greater than that of the index 10. In order to reduce reallocation calls, the CPU 2C may optionally increase the array size 18 by a predetermined numerical value, or alternatively by a predetermined percentage of a previous array size 18. In step 7.10 the CPU 2C initializes new array elements with a pointer PTR.0000-PTR.N to the group one 20. The CPU 2C then terminates the process in step 7.12.

Referring now generally to the Figures and particularly to FIG. 8, FIG. 8 is a flowchart of a yet further aspect of the invented method wherein the software 4 directs the CPU 2C to execute a first method for the process of splitting a group. In step 8.02 the CPU 2C creates a first new container C.NEW.0001 and a second new container C.NEW.0002. In step 8.04 the CPU 2C calculates a split number 24. In step 8.06 the CPU 2C determines whether to acquire a next pair 34 from a source group 26. When the determination in step 8.06 is positive, the CPU 2C advances to step 8.08, wherein the CPU 2C determines whether the key K.0000-K.N is less than a split number 24. When the CPU 2C determines in step 8.08 that the key K.0000-K.N is less than the split number 24, the CPU 2C advances to step 8.10, wherein the CPU 2C adds a key value pair KP.0000-KP.N to the first new container C.NEW.0001. When the determination in step 8.08 is negative, and the CPU 2C determines that the key K.0000-K.N is not less than the split number 24, the CPU 2C adds the key value pair KP.0000-KP.N to the second new container C.NEW.0002 in step 8.12. The CPU 2C subsequently advances from the execution of either step 8.10 or step 8.12 to the re-execution of the loop of steps 8.06 through 8.12, until the determination in step 8.06 is negative.

When the determination in step 8.06 is negative, i.e. the CPU 2C determines not to retrieve a subsequent key value pair KP.0000-KP.N from the source group 26, the CPU 2C advances to step 8.14. In step 8.14 the CPU 2C sets a split index 10 equal to the split number 24 divided by the container size 8. For each of the array elements 32 which have an index 10 greater than the split index 30 and which point to the source group 26, the CPU 2C changes the array elements to point to the first new container C.NEW.0001 in step 8.16. For each of the array elements 32 which have an index that is greater than or equal to the split index 30 and which point to the source group 26, the CPU 2C changes the elements to point to the second new container C.NEW.0002 in step 8.18. The CPU 2C then advances to step 4.20, wherein the CPU 2C terminates the process.

Referring now generally to the Figures and particularly to FIG. 9, FIG. 9 is a flowchart of a yet further aspect of the invented method whereby the software 4 directs the CPU 2C to utilize a second method for the execution of the process of a split group. In step 9.02 the CPU 2C creates a new container C.NEW. In step 9.04 the CPU 2C calculates a split number 24. In step 9.06 the CPU 2C determines whether to acquire a next pair 34 from the source group 26. When the determination in step 9.06 is positive, i.e. the CPU 2C determines to acquire the next pair 34, the CPU 2C advances to step 9.08, wherein the CPU 2C determines if the key K.0000-K.N is greater than the split number 24. When the CPU 2C determines in step 9.08 that the key K.0000-K.N is not greater than the split number 24, the CPU 2C advances to step 9.10 wherein the CPU 2C adds the key value pair KP.0000-KP.N to the new group 22 and removes the key value pair KP.0000-KP.N from the source group 26. The CPU 2C subsequently advances from a positive determination in step 9.08, or from the execution of step 9.10 to a re-execution of the loop of steps 9.06 through 9.10, until the determination in step 9.06 is negative.

When the determination in step 9.06 is negative, and the CPU 2C determines to acquire a subsequent key value pair 28 from the source group 26, the CPU 2C advances to step 9.12. In step 9.12 the CPU 2C sets the split index 30 equal to the split number 24 divided by the container size 8. In step 9.14, for each of the array elements 32 which have an index 10 which is greater than or equal to the split index or which points to the source group 26, the CPU 2C changes the array elements 32 to point to the new group 22. The CPU 2C terminates the process in step 9.16.

Referring now generally to the Figures and particularly to FIG. 10, FIG. 10 is a flowchart of a yet further aspect of the invented method, whereby the CPU 2C utilizes a third method for the process of a splitting a group. In step 10.02 the CPU 2C acquires a minimum value of an initial key Kmin and a maximum value of a key Kmax from the designated container C.0000-C.N. In step 10.04 the CPU 2C sets an index1 34 equal to the initial key Kmin divided by the container size 8. In an alternate embodiment of step 10.04, the CPU 2C shifts the key K.0000-K.N n bits to the right, instead of dividing the key K.0000-K.N by the container size 8 if the group size is equal to 2ⁿ. In step 10.06 the CPU 2C sets an index2 36 equal to the maximum key value Kmax divided by the container size 8. The CPU 2C in step 10.06 determines whether the index1 34 and the index2 36 are equal. When the determination in step 10.08 is positive, the CPU 2C selects an alternate container type C.TYPE.ALT for the group 14 without splitting the group 14. Alternatively, when the determination in step 10.08 is negative, i.e. when the CPU 2C determines that the index1 34 and the index2 36 are not equal, the CPU 2C advances to step 10.12, wherein the CPU 2C utilizes the methods of FIG. 8 and FIG. 9 to split the group 14. The CPU 2C advances to step 10.14 either from the execution of step 10.10 or, alternatively, from the execution of step 10.12. In step 10.14 the CPU 2C terminates the process.

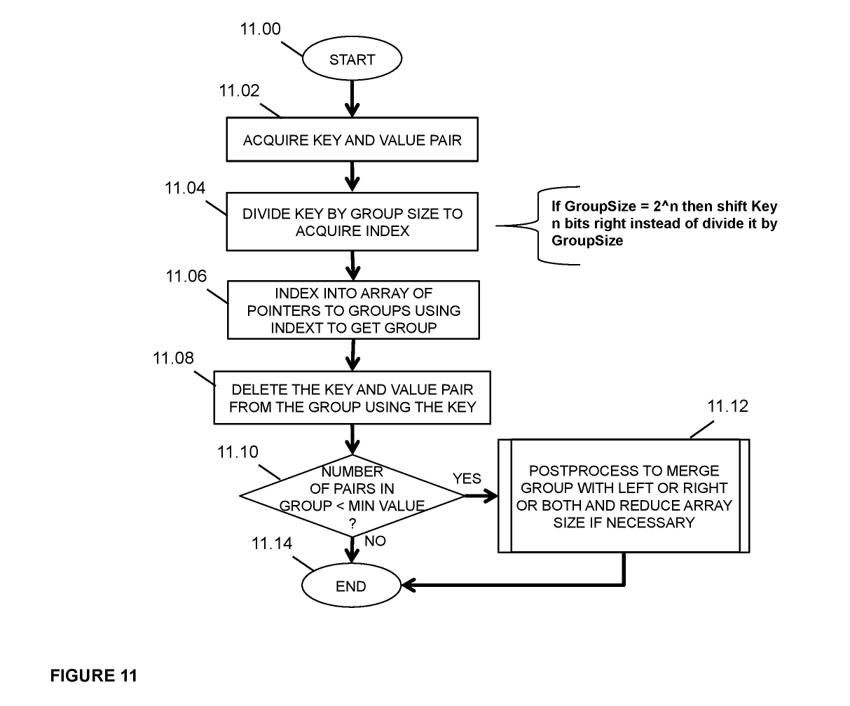

Referring now generally to the Figures and particularly to FIG. 11, FIG. 11 is a flowchart of a yet further aspect of the invented method, whereby the software 4 directs the CPU 2C to delete a bitset 6. In step 11.02 the CPU 2C acquires a key value pair KP.0000-KP.N. In step 11.04 the CPU 2C divides the key K.0000-K.N by the container size 8 to acquire the index 10. In an alternate embodiment of step 11.04, the CPU 2C shifts the key K.0000-K.N n bits to the right, instead of dividing the key K.0000-K.N by the container size 8 if the container size 8 is equal to 2ⁿ. In step 11.06 the CPU 2C indexes into the array of references to groups 12 using the index 10 to acquire the group 14. In step 11.08 the CPU 2C deletes the bitset 6 from the group 14 using the key K.0000-K.N. In step 11.10 the CPU 2C determines whether the number of key value pairs KP.0000-KP.N in the group is less than the minimum value 38. When the determination in step 11.10 is positive, the CPU 2C executes a post process to merge the group 14 with the a group to the left 40 or with a group to the right 42, or with both, and to reduce the array size 18 if necessary. Subsequent to a negative determination in step 11.10, or alternatively to the execution of step 11.12, the CPU 2C advances to step 11.14. In step 11.14 the CPU 2C terminates the process.

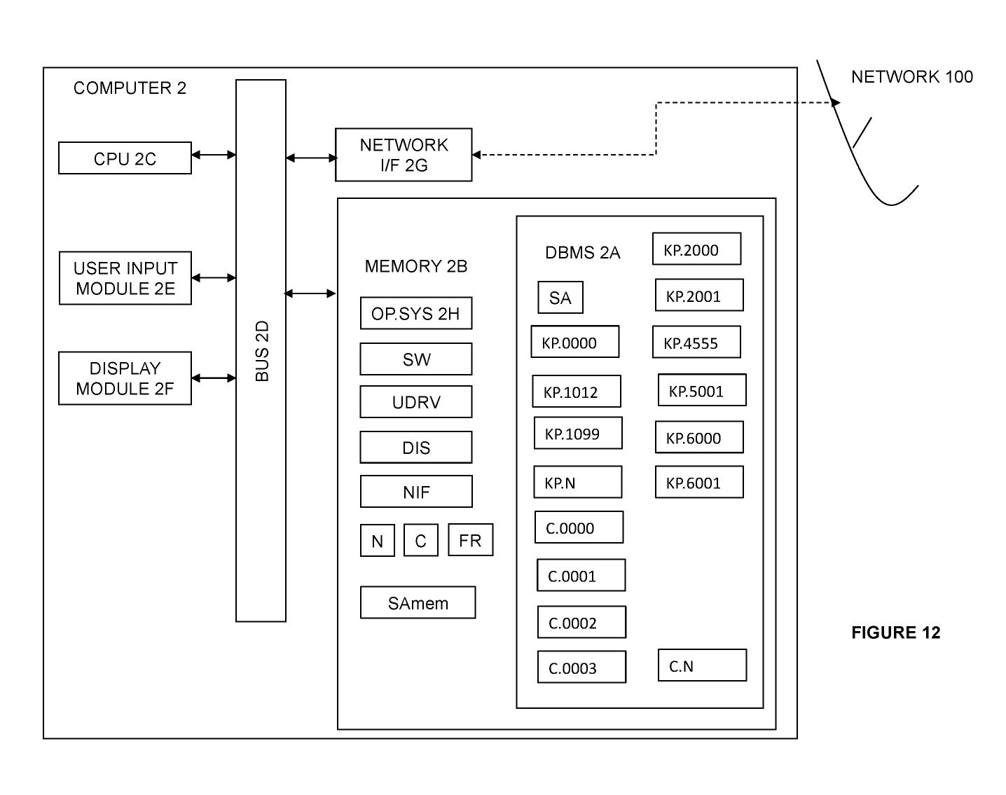

Referring now generally to the Figures and particularly to FIG. 12, FIG. 12 is a block diagram of the computer 2 of FIG. 1 through FIG. 11. A computer operating system software OP.SYS 2H of the computer 2 may be selected from freely available, open source and/or commercially available operating system software, to include but not limited to a LINUX™ or UNIX™ or derivative operating system, such as the DEBIAN™ operating system software as provided by Software in the Public Interest, Inc. of Indianapolis, Ind.; a WINDOWS XP™, VISTA™ or WINDOWS 7™ operating system as marketed by Microsoft Corporation of Redmond, Wash.; or the MAC OS X operating system or iPhone G4 OS™ as marketed by Apple, Inc. of Cupertino, Calif.

The computer 2 further includes the central processing unit 2C that is bi-directionally communicatively coupled by an internal communications bus 2D with (a.) an optional user input module 2E that accepts input, e.g., information and commands, from a user, (b.) an optional video display module 2F that provides visual information rendering output, (c.) a network interface 2G that bi-directionally communicatively couples the CPU 2C with alternate devices (d.) the system memory 2B. Stored within the system memory 2B, is the operating system OP.SYS 2H, the invented software SW, a user module driver UDRV, an optional display driver DIS a network interface driver NIF enables the network interface 2F to bi-directionally communicatively couple the CPU 2C with optional additional devices, the DBMS 2A, and the software structures and digitally stored information described within the present disclosure.

The invented software SW enables the computer 2 and the CPU 2C to execute, perform and instantiate aspects of the invented method as disclosed within FIGS. 1 through 11 and accompanying descriptions. The user input module driver UDRV enables the user module 2C to input information and commands entered by a user into the CPU 2C. The display driver DIS enables the CPU 2C to visually render information by means of the video display module 2D. The network NIF enables the network interface module 2E to bi-directionally communicate with optional alternate devices.

In certain yet optional preferred embodiments of the invented method, the system software SW optionally includes or employs, and enables the computer 2 to apply, the following pseudocode to the DBMS 2A in a search of the key value pairs KP.0000-KP.N

for(int i=0; i<N;i++){

ValueType v = map(i);
if( v != <emptyvalue>){

// now we have value: v for key: i
// and can process it

}else{

//value not found for key i

}

}

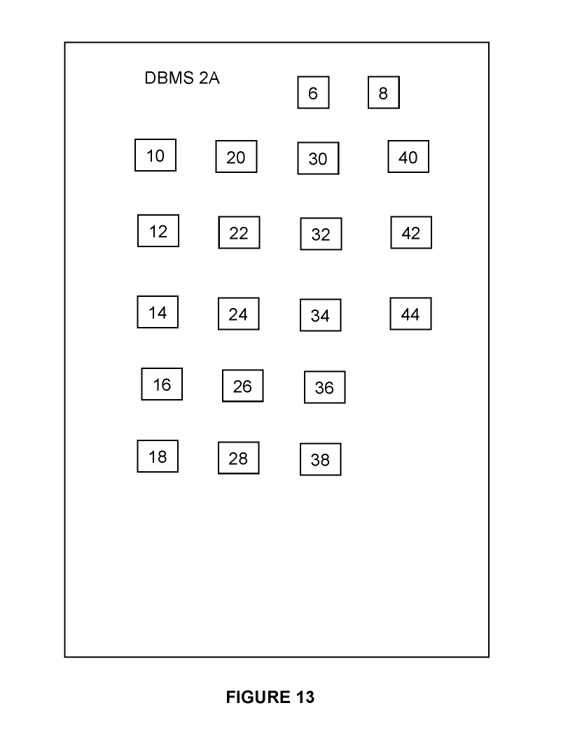

Referring now generally to the Figures, and particularly to FIG. 13, FIG. 13 is a block diagram of additional aspects of the DBMS 2A, wherein a plurality of data structures 6 through 44 of the methods of FIG. 5 through FIG. 11 are stored.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a non-transitory computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based herein. Accordingly, the disclosure of the embodiments of the invention is intended to be illustrative, but not limiting, of the scope of the invention, which is set forth in the following claims.

What is claimed is:

1. A computer-implemented method comprising:
forming a plurality of M key-value pairs, wherein the maximum value of any key of the plurality of: M key-value pairs is an N value and the N value is less than an M count of the quantity of key-value pairs of the plurality of M key-value pairs; and
a method in accordance of the following pseudocode is employed in searching the plurality of M key-value pairs:
for(int i=0; i<N;i++){
ValueType v = map(i);
if( v != <emptyvalue>){
// surfacing a value: v for key: i
// and that can be processed
}else{
//value not found for key i
}
}.
